(19) United States
(12) Patent Application Publication
(10) Pub. No.: US 2012/0262787 A1
(43) Pub. Date: Oct. 18, 2012

(54) PIXELATED, DIFFRACTIVE OPTICAL ELEMENT HAVING TWO HEIGHT STEPS FOR THE PRODUCTION OF A PHASE DISTRIBUTION WITH AN ARBITRARY PHASE DEVIATION

(75) Inventors: Uwe Detlef Zeitner, Weimar (DE); Dirk Michaelis, Jena (DE); Ernst-Bernhard Kley, Jena (DE); Thomas Kämpfe, Jena (DE); Wiebke Freese, Jena (DE)

(73) Assignee: FRIEDRICH-SCHILLER-UNIVERSITÄT, Jena (DE)

(21) Appl. No.: 13/390,472

(22) PCT Filed: Aug. 13, 2010
(86) PCT No.: PCT/EP2010/004996

§ 371 Date: Jun. 27, 2012

(30) Foreign Application Priority Data
Aug. 14, 2009 (DE) 10 2009 037 629.1

(51) Int. Cl. G02B 5/18

(52) U.S. Cl. 359/558

(57) ABSTRACT

A diffractive optical element generates a phase distribution with an arbitrary quasi-continuous phase deviation. The diffractive optical element includes a plurality of pixels configured to generate an adjustable phase deviation. Each pixel has a base face, and the plurality of pixels being disposed adjacent each other with their base faces in an element plane of the diffractive optical element. One or more pixels of the plurality of pixels includes a height profile formed by a first face and a second face of the one or more pixels. A distance between the first face and second face defining a height step that is tuned to an adjustable maximum phase deviation of the diffractive optical element.

The present invention relates, in the field of diffractive optics, to a pixelated, diffractive optical element for the production of an arbitrary quasi-continuous phase deviation.

Various variants for diffractive elements which comprise a large number of pixels are known from the state of the art. For the generation of a phase distribution with an arbitrary continuous phase deviation, the pixels of a diffractive element are normally configured in the form of blocks with the same base face and a different height. A refractive element having for example four phase steps is constructed from four different types of pixels which differ merely in their height. The number of types of pixels is adapted to the number of phase steps. Diffractive elements, the height variation of which in the surface profile is caused by a combination of pixels of a different height, are generally produced by means of a variable-dose method, by means of multiple exposure or by means of a multiple-etching method.

Since however, variable-dose methods and multiple exposure or multiple etching methods are complicated to implement and time-consuming, also diffractive elements having a subwave structure and merely one height step are known as an alternative. The subwavelength structure thereby has the shape of periodic, single- or two-dimensional gratings or repeating unit cells. The gratings or unit cells have respectively only one height step so that such diffractive elements can also be produced simply in a single exposure or etching process. Diffractive elements made of pixels having a subwavelength structure comprise a combination of pixels, the phase deviation being adjustable by means of different subwavelength structures of adjacent pixels.

The production of diffractive elements, the pixels of which have subwavelength structures, is simplified relative to the production of diffractive elements having pixels of a different height. However, the production of subwavelength structures also entails problems because of their small size of the subwavelength structures. In addition, repetition of the unit cell within one pixel leads to a restriction in the minimum pixel size which is technologically achievable.

The object of the present invention now resides in making available a diffractive element which can be produced in a simple and more economical manner, produces a predetermined phase deviation for each pixel and resolves the above-mentioned problems of already known diffractive elements.

The above-mentioned object is achieved by the pixelated diffractive optical element according to claim 1. Advantageous developments of the present invention are given in the respective dependent claims.

According to the invention, a diffractive optical element for the production of a phase distribution with an arbitrary quasi-continuous phase deviation has an element plane and a large number of different pixels for the production of an adjustable phase deviation, the individual pixels being disposed next to one another with their base face in the element plane. At least a part of the pixels thereby has a height profile. Each of the pixels with a height profile thereby has two separate regions of a different area, the two separate regions not necessarily forming a continuous face. The two separate regions are subsequently termed first and second face, the second face being situated preferably in the element plane and corresponding to a part of the base face. A height step is produced between the first and the second face, which height step is tuned to an adjustable maximum phase deviation of the diffractive optical element and has essentially a constant height difference for the pixels with a height profile. Hence the first face is disposed preferably offset relative to the element plane in the direction of the incident light. In the case where the element plane is orientated horizontally and the light falls onto the element perpendicularly from above, the first face is disposed above the second face, i.e. at a higher height level than the second face.

Furthermore, the first face and the base face define a face ratio by means of which a phase deviation between a minimum and the maximum phase deviation of the diffractive optical element can be adjusted continuously. For the phase deviation φ of one pixel, there applies approximately:

$$ϕ ∼ \frac{first face}{base face}$$

There can be understood by the maximum phase deviation of the diffractive element, the maximum phase deviation of the entire diffractive optical element. On the other hand, also a local maximum in the phase deviation can occur within a region of the optical element in which pixels with a high height profile are contained and can be understood as maximum phase deviation. Correspondingly, there should be understood by minimum phase deviation, the minimum phase deviation of the entire optical element or the local minimum phase deviation within a region which contains pixels with a height profile.

Preferably, the diffractive optical element has, besides the pixels with a height profile, in addition pixels without a height profile which are divided into empty and full pixels. Empty pixels are thereby defined as blocks, the surface of which, which is orientated away from the element plane, is situated in one plane with the lower face, i.e. the second face, of a pixel with a height profile. Correspondingly, full pixels are pixel blocks, the upper side of which is situated in one plane with the upper face, i.e. with the first face, of the pixels with a height profile. Empty and full pixels should be understood finally as limiting cases of pixels with a height profile. In the case where the diffractive optical element consists of empty pixels, full pixels and pixels with height profiles, the maximum phase deviation of the entire diffractive element is prescribed by the full pixels and the minimum phase deviation by the empty pixels.

According to the invention, the diffractive optical element has at least two different types of pixels which differ from each other by a different shaping and/or different extension of the first upper face of a pixel or of a different design of a total pixel. Pixels which are selected from the at least two types of pixels are disposed relative to each other, according to the invention, such that they form a pattern without periodic repetition at least in regions. The pixels which are selected from the at least two types of pixels can hence be disposed in an arbitrary sequence in order to achieve phase distributions with quasi-continuous phase steps disposed arbitrarily.

The difference between various types of pixels can reside, on the one hand, in the shaping and/or extension of the first face of a pixel which is higher relative to the second face and, on the other hand, in the difference between pixels with a height profile and pixels without a height profile. If the diffractive element contains for example four types of pixels, namely full pixels, empty pixels, pixels with a lesser extension of the first face and pixels with a greater extension of the first face, then these types of pixels are disposed such that the diffractive element has, at least in regions, no periodic repetitions of pixels of the four types of pixels. According to the number of desired phase steps of the diffractive element, the latter has a correspondingly high number of different types of pixels.

The diffractive element according to the invention is preferably a binary element which can be broken down into two surface regions, between which the height step is produced. Accordingly, the diffractive element preferably has merely empty pixels, full pixels and pixels with a height profile, the height step for all pixels with a height profile being equal and the height difference therefore being constant.

Preferably, a pixel with a height profile has precisely one element having an arbitrary surface profile. The surface profile is thereby preferably given by the shaping and/or extension of the first face of the pixel. Such an element having an arbitrary surface profile can be for example a column or a web on an empty pixel, i.e. on the base face, or a hole or a groove in a full pixel, i.e. starting from the first face in the direction of the second face. Irrespective of the surface profile of the element, the phase deviation of the pixel results from the ratio of the first face to the base face.

The base face of a pixel, preferably of all pixels of one element, preferably has a triangular or polygonal configuration. In particular base faces which have a square or hexagonal shape are used for preference. The base face can have in addition or alternatively a maximum lateral extension <5λ, preferably ≦2λ, λ being the wavelength of incident radiation or an illuminating wave.

In order to achieve a polarisation-independent phase distribution, symmetrical pixels can be used. Such pixels are produced if the first or the second face of one pixel having a preferably symmetrical base face has a symmetrical shape which is positioned centrally relative to the base face. Square or circular faces are used preferably as symmetrical shape. Asymmetrical intensity distributions in the Fraunhofer region, which are reflected in a preferred direction of the spatial frequencies of the diffractive element, can be reproduced by asymmetrical shaping of the first or of the second face of a pixel having a symmetrical and/or asymmetrical pixel base face. Shapes which are positioned centrally or decentrally relative to the base face, for example rectangular or oval shapes, are used preferably as asymmetrical shape. Alternatively, also square or circular first or second faces which are disposed decentrally relative to the base face can also define the asymmetrical shape of the pixel. Asymmetrically shaped pixels reveal in general however a polarisation sensitivity which should be correspondingly taken into account in the design process of the diffractive element. It is hence possible to use the double-refractive property in the element design or to reduce the polarisation sensitivity by the structuring in a low-refractive material with a refractive index n<1.6.

The pixels of a diffractive element according to the invention are preferably configured such that the second face, which is preferably a part of the base face, abuts at least in regions or completely against the circumferential edge of the base face and/or surrounds the projection of the first face on the base face. Alternatively however, also the projection of the first face on the pixel base face can surround the second face, which is itself a part of the base face (or is situated in the plane of the base face), then the projection of the first face abutting completely against the circumferential edge of the base face. If, for example, the first face is the surface of a web, then the second face, which in this case is divided in two, abuts in regions against the circumferential edge of the base face. If the first face is provided by the upper side of a column, then the second face surrounds the projection of the first face. In contrast thereto, the projection of the first face surrounds the second face if the second face is configured as a hole or shaft. Alternatively, if the second face is configured as the base face of a groove, then also the projection of the first face, which in this case is divided into two, abuts against the circumferential edge of the pixel base face.

As already explained above, the diffractive element can have, in addition to the pixels with a height profile, pixels without a height profile. In the case of the present invention, these should be divided preferably into two groups, namely into empty pixels and full pixels. A full pixel is thereby as a block with an upper side which is orientated away from the element plane and is situated in a plane with the first face of the pixels with a height profile. A full pixel thus concerns a limiting case of pixels with a height profile, the first face corresponding to the base face and the second face vanishing, i.e. having a face extension of 0. An empty pixel can, in contrast, be disposed as a block with an upper side, i.e. a side which is orientated towards the first face, in a plane with the second face or the base face. Also empty pixels concern again a limiting case of pixels with a height profile, the second face corresponding to the base face and the first face vanishing, i.e. the extension thereof becoming 0.

The height step between first and second face of a pixel has preferably a height difference in the range of 0 to 4λ, preferably in the range of 0 to 3λ, λ in turn being the wavelength. In general, the height difference h between the first and second face depends upon the quantisation, i.e. the number of phase steps k, the refractive index n, the wavelength λ and the functionality, i.e. the use as transmission or reflection element. As an approximation, the profile height of a transmission element can be calculated alternatively by the following formula:

$$h \approx a \frac{( k - 1 )}{k} \frac{λ}{( n - 1 )} ,$$

a being a natural number. If, however, the element is intended to be used as a reflection element consisting of a reflecting layer and a dielectric layer, responsible for the phase deviation, with pixels which have a height profile at least in part, then as an approximation there applies the formula:

$$h \approx \frac{1}{2} a \frac{( k - 1 )}{k} \frac{λ}{( n - 1 )} ,$$

The height difference h has the same value for all pixels with a height profile in the diffractive element. Hence the phase deviation can be determined solely via the surface extension, the phase deviation increasing with increasing extension of the first face. In the case of an empty pixel, the phase deviation is minimal, whilst the phase deviation is maximum in the case of a full pixel.

In the production technical implementation of diffractive elements according to the invention, it should be taken into account that the first as well as the second face of at least individual pixels are slightly rounded so that the surface profile is not an ideal plane. In addition, the result, during the etching process, can be undesired height variation amongst the pixels since for example regions with narrow columns, i.e. greater extension of the second faces, are generally etched more deeply as a function of the process than regions with broad columns, i.e. a larger extension of the first face. The result can therefore be deviations from the ideal structure of the elements, which are preferably in the range of less than ±λ/10.

Diffractive elements according to the invention can be configured as transmission element or as reflection element. In contrast to a transmission element, a reflection element, consisting of one reflecting layer and one dielectric layer, responsible for the phase deviation, with pixels which have a height profile at least in part, has an essentially halved height difference between the first and the second face. The reflection layer preferably consists of a material which is reflecting in a desired wavelength range or comprises such. Preferably metals are used as materials.

The diffractive optical element preferably consists of a material with a refractive index in the range of n=1 to n=4 or comprises such a material. For example, silica glass with a refractive index of n≈1.5 can be used. In the case of silica glass, the phase deviation behaves almost/approximately proportionally to the face ratio between the first face and the base face. Alternatively, the diffractive optical element can also consist of polymers, for example PMMA (polymethylmethacrylate), fluorides, for example MgF₂ or CaF₂, oxides, for example Ta₂O₅, ZnO, TiO₂ or Al₂O₃, and/or diamond or at least comprise one of these materials.

For preference, the diffractive optical element according to the invention has a planar element plane. In such a case, the first face, the second face and the base face of the pixels are disposed parallel to the element plane. Alternatively, the element plane can also have a concave or convex configuration or have a more complex basic structure, possibly with a large number of maxima and minima. For example, a suitable choice of the element plane can facilitate the design from a production point of view in the case of beam formers.

The total extension of the diffractive element and hence the number of individual pixels is dependent upon the type of application of the diffractive element. The elements can be in the range of a few millimetres to a few metres, in particular in the range of a few centimetres to a few metres.

The present invention relates furthermore to a method for the production of a diffractive element according to the invention. The structure of the diffractive phase element is written firstly with microlithographic means, e.g. electron beam lithography, photolithography, laser writing and/or similar methods, and subsequently transferred by current dry- and/or wet-chemical etching methods into the material of the diffractive element. For example, a photoresist layer which is exposed in a subsequent operating step is applied firstly on a substrate. After development of the photoresist, the thus produced height profile can be transferred to the substrate by an etching process.

Furthermore, the present invention relates to the use of a diffractive optical element according to the invention for testing a phase function of a phase element, for beam formation and/or for producing arbitrary intensity distributions in the Fraunhofer region. In addition, diffractive elements can also be used as patterns for the replication, for example as imprint stamp or as master for holographic contact copies.

Various examples and results for different diffractive elements according to the invention are provided subsequently. There are shown

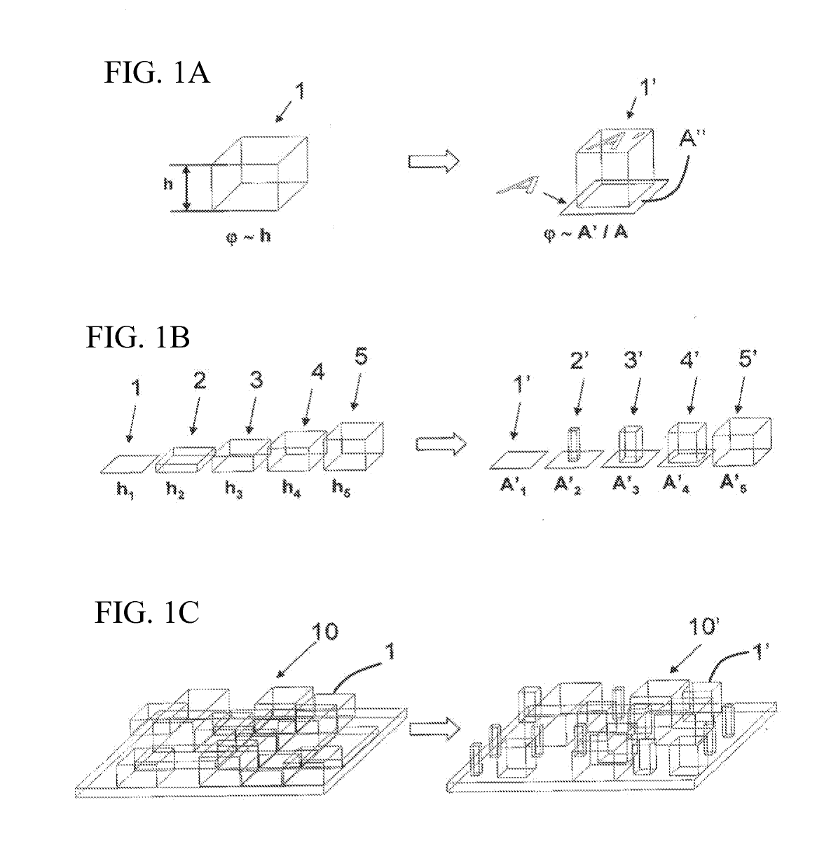

FIGS. 1A to 1C a comparative illustration between diffractive elements with a plurality of height steps and those with a height step and different column sizes;

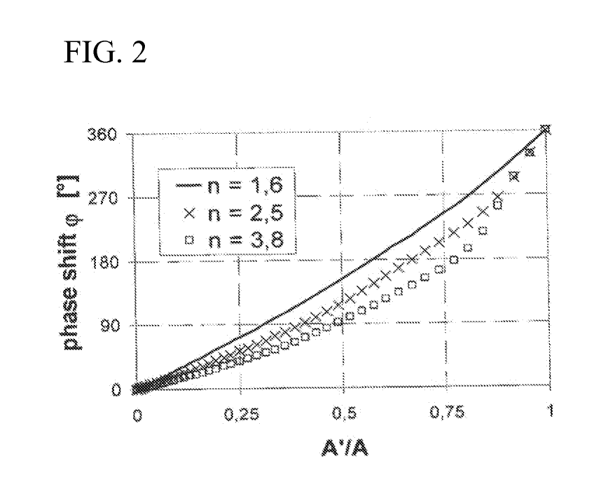

FIG. 2 a diagram for the dependence of the phase deviation upon the ratio of a first face A′ to a base face A as a function of the refractive index;

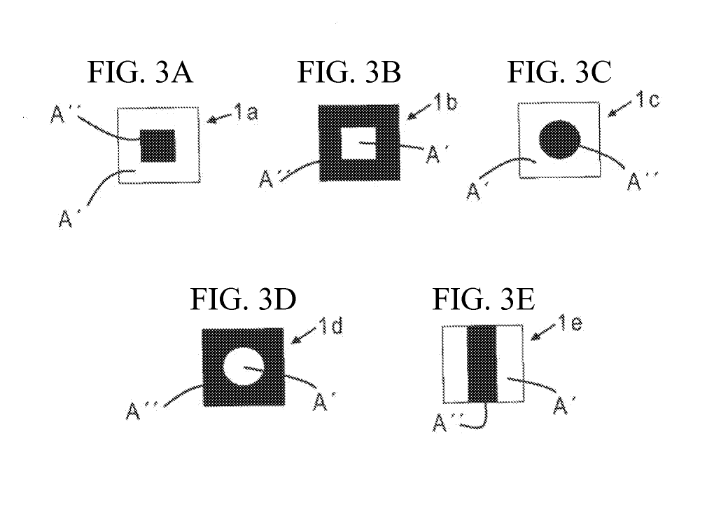

FIGS. 3A to 3E possible surface profiles of a pixel having respectively a first and a second face;

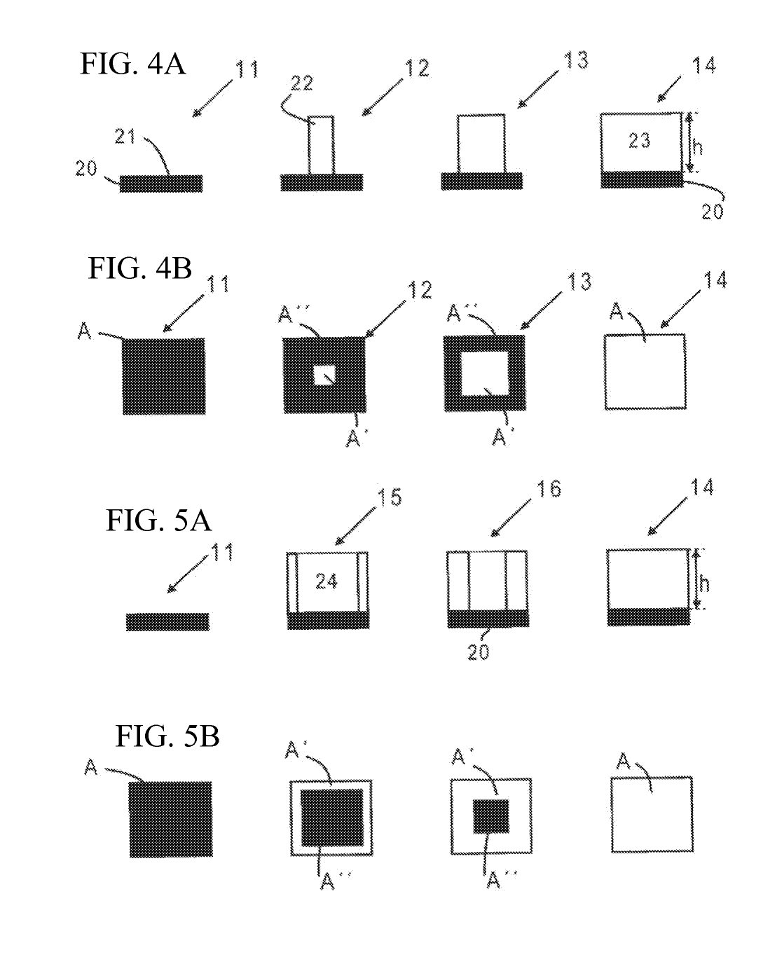

FIGS. 4A and 4 side- and plan view of four different types of pixels of a diffractive element according to the invention;

FIGS. 5A and 5B side- and plan view of a further four different types of pixels of a diffractive element according to the invention;

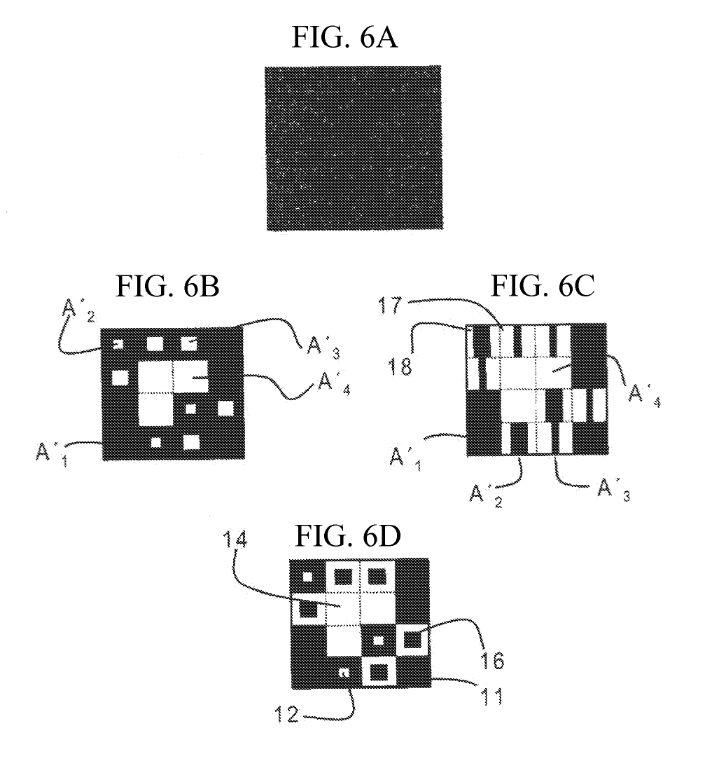

FIGS. 6A to 6D possibilities for conversion of a phase element with four phase steps;

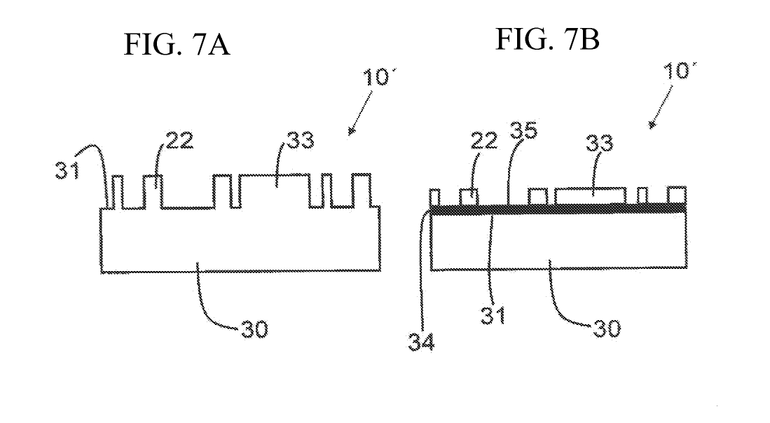

FIGS. 7A ad 7B side view of a phase element in reflection and of a phase element in transmission;

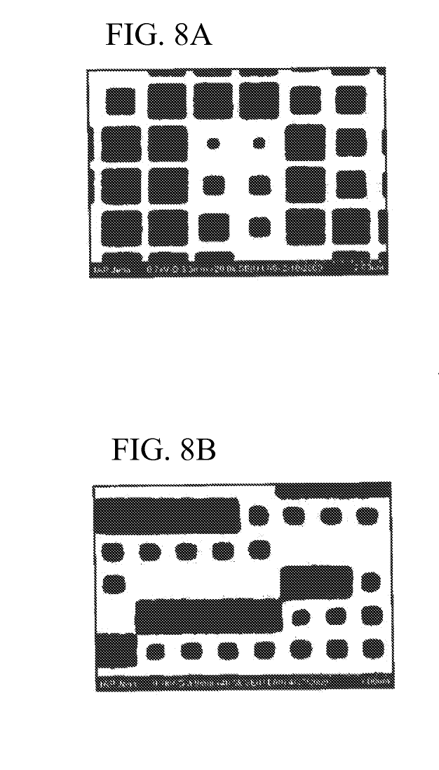

FIGS. 8A and 8B REM recordings of a 5-phase element and also of a 3-phase element; and

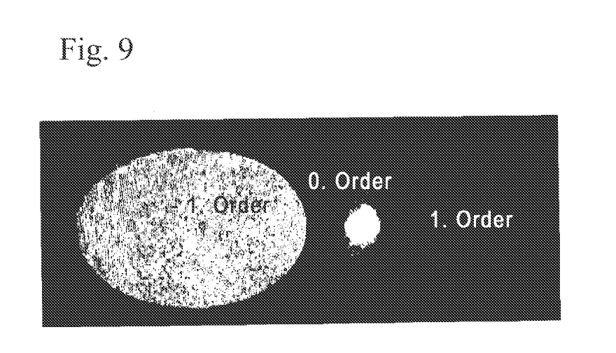

FIG. 9 the intensity distribution in the Fraunhofer region of a three-step computer-generated hologram.

FIGS. 1A to 1C respectively show, in the left picture region, one or more pixels of a diffractive element with an arbitrary number of height steps. In contrast thereto, FIGS. 1A to 1C respectively, in the right picture region, show one or more pixels of a diffractive element with merely one height step, the surface ratio of the first face A′ to the base face A of the pixel base being variable. The base face A is composed of the sum of the first face A′ and the second face A″ and is the same for all pixels of the diffractive element or of a partial region of the element.

The pixel illustrated in FIG. 1A on the left has a specific height h to which the phase deviation φ is proportional. On the right in FIG. 1A, again a pixel is represented, this having a first face A′ and a base face A and the phase deviation φ being approximately proportional to the ratio of the first face A′ to the base face A. This almost linear ratio between phase deviation φ and the ratio of the first face A′ to the base face A applies in particular for materials with refractive indices n which are not too large, i.e. for materials with n≧1.6. For larger refractive indices n, the linear proportionality is lost, as explained further on.

FIG. 1B shows, in the left picture region, the pixels 1 to 5 which have heights h₁ to h₅. In the right picture region, pixels 1′ to 5′ are illustrated, the first faces A′ varying between A′₁ to A′₅, A′₁=0 and A′₅=A applying, and all pixels having a constant height jump. Pixels 1 and 1′, 2 and 2′, 3 and 3′, 4 and 4′ or 5 and 5′ respectively define an equal phase jump φ.

In FIG. 1C, a diffractive element 10 with height variation and a diffractive element 10′ according to the invention with surface variation and only one height jump with individual pixels 1 and 1′ are now illustrated, pixels disposed respectively at equivalent positions defining an equal phase deviation φ.

As mentioned above already, the proportionality between phase deviation φ and the ratio of first face A′ to the base face A is dependent upon the refractive index n.

The phase shift produced by the element can be determined rigorously with the RCWA (rigorous coupled wave analysis) algorithm (also known as FMM for Fourier-modal method) when accepting a periodic repetition of the pixel. An approximate determination of the phase deviation is possible by means of EMT (Effective Medium Theory). The condition for the latter approach is that the side length of the pixel face A must be smaller than λ/n (for vertical light incidence), n standing for the refractive index of the material used. Both methods are base faced however on an infinite extension of the periodically repeating unit cell in both lateral spatial directions. Since this is not the case in the present invention, these approaches can be used merely for approximate determination of the phase deviation since one and the same pixel need not be repeated periodically. The influence of the neighbouring pixels on the generated phase of a considered pixel hence remains outwith consideration. In order to increase the efficiency of a phase element, this influence can be taken into account in a corresponding element design.

FIG. 2 shows the phase shift of a subwavelength grating (A<λ/2n), which is calculated by means of the RCWA algorithm, as a function of the surface filling A′/A for three different refractive indices. The calculation is base faced on a square profile of the first face A′.

For a refractive index n₁=1.6, it is recognised that the phase deviation shows an almost linear course as a function of the face filling A′/A. For an increasing refractive index n₂=2.5 and n₃=3.8, this course becomes increasingly non-linear.

FIGS. 3A to 3E respectively show pixel structures, the base face A basically having a square configuration, whilst the first face A′ is variable. The respectively black face is thereby situated respectively offset by a constant height step at the level of the white face, i.e. the first face A′ is white and the second face A″ is illustrated black.

In FIG. 3A there is a pixel with a square base face A, a first face A′ surrounding a second face A″ with a square upper side which is offset by a height difference in the direction of the pixel base face. The pixel la illustrated in FIG. 3A is configured as a hole with a square base face A″ in the first face A′.

The pixel 1b illustrated in FIG. 3B is configured complementary to the pixel 1a of FIG. 3A, i.e. the first face A′ is configured as the upper side of a column on the second face A″. FIG. 3C shows a pixel 1c which is configured similarly to the pixel 1a. However, the hole in the first face A′ has a circular configuration and the base face of the hole hence defines a circular second face A″. The pixel 1d of FIG. 3D is the complementary structure to the pixel 1c, i.e. the second face A″ which has a circular configuration is situated at a lower height level than the first face A′. The pixel 1e illustrated in FIG. 3E has an asymmetrical construction in contrast to the previously described pixels. The second face A″ which is configured as the base face of a groove and surrounds the first face A′ is detected therein. Pixels with asymmetrical structures generally show a polarisation sensitivity.

FIG. 4A shows four different types of pixels 11 to 14 which can be combined to form a diffractive element with four phase steps. FIG. 4B shows the types of pixels 11 to 14 in plan view, represented in FIG. 4A. The type of pixel 11 represents an empty pixel which has a square base face A. In the case of the type of pixel 11, the upper side 21 of the element plane characterised with the reference number 20 defines the second face A″ which corresponds with the base face in the case of the type of pixel 11, whilst the first face A′ has an extension of zero.

The type of pixel 12 again shows a base face on the element body 20, on which a square column 22 is disposed. The upper side of the square column forms the first face A′, the projection of which on the base face is surrounded by the second face A″.

In contrast to the type of pixel 12, the type of pixel 13 has a wider square column 22 so that the face A′ is greater in the case of the type of pixel 13 than the first face A′ of the type of pixel 12.

The type of pixel 14 now describes a full pixel, i.e. a block is placed on the upper side 21 of the element body indicated with the reference number 20, the area of which of its upper side corresponds to the extension of the base face A. The height h of the block 23 of the type of pixel 14 corresponds to the height of the columns 22 of the types of pixels 12 and 13.

FIGS. 5A and 5B again show the types of pixels 11 and 14, i.e. an empty and a full pixel, which illustrate a limiting case of pixels with a height profile. Furthermore, FIGS. 5A and 5B show the types of pixels 15 and 16, a hole 24 or shaft being shown instead of the column 22. In the type of pixel 15, the projection of the first raised face on the base face surrounds a second face A″ of a square configuration which is displaced by a height difference h in the direction of the element body 20 into the plane of the base face. In contrast to the type of pixel 15, the type of pixel 16 has a hole with a lesser extension, i.e. the second face A″ of the type of pixel 16 has a lesser extension than the second face A″ of the type of pixel 15.

FIG. 6A shows a phase element with four phase steps. FIGS. 6B to D respectively show an enlargement of a possible configuration of an element with four phase steps. FIG. 6B shows a cut-out of 4×4 pixels, the pixel having the types of pixels 11 to 14 illustrated in FIGS. 4A and 4B. The first face A′ can thereby have an area of A′₁=0, A′₂=C1, A′₃=C2 or A′4=A, there applying C1<C2 and the variables C1 and C2 respectively defining a constant face.

FIG. 6C shows a diffractive element, the types of pixels 11, 14, 17 and 18 being used. The types of pixels 17 and 18 have the pixel structure 1e with a groove which is represented in FIG. 3E. The grooves respectively have different widths or base faces A″. The first face A′ in this case is subdivided by the groove and its face corresponds to a value A′₂=C3 or A′₃=C4, C3 and C4 in turn being constant and C3<C4 applying.

FIG. 6D now shows a phase element having four phase steps, types of pixels having two different surface profiles being selected in addition to empty pixels 11 and full pixels 14. On the one hand, the pixel structure 1a, on the other hand the pixel structure 1b was selected from FIGS. 3A and 3B. In total, the element comprises the four different types of pixels 11, 12, 14 and 16. There applies thereby for the types of pixels 11 or 14, A′=0 or A′=A. The first face A′ of the pixel shape 12 corresponds to a constant value C1 and the first face A′ of the pixel shape 16 corresponds to a constant face C4. There applies thereby for the constant faces C1>C4.

FIGS. 7A and 7B now show a cross-section through a phase element which is configured for a transmission (FIG. 7A) or a reflection (FIG. 7B). The diffractive element 10′ of FIG. 7A has an element body 30 in the form of a substrate which is transparent for the incident light and is preferably a dielectric, the surface 31 of which forms a first height level and is subdivided into individual pixels, the respectively second faces of the pixels being disposed in the surface 31. A constant height step forming the webs or columns 22 or also the profile configurations 33 of the individual pixels which are complementary thereto, as are proposed for example in FIGS. 3A and 3C, are raised from the surface 31 to form a surface profile which produces a phase deviation.

FIG. 7B in turn shows a body 30 of the diffractive element 10′ made of a medium which is transparent or non-transparent for the incident light, on the surface 31 of which an additional layer 34 made of a metal is disposed. On the upper side 35 of the layer 34 there are disposed columns 22 or profiles 33 of the individual pixels which are of a complementary configuration and consist of a dielectric or comprise such, to form a surface profile which produces the phase deviation. It is also shown in FIG. 7B that merely one height step is present. The height step of the element in reflection is however halved in comparison with the element in transmission (FIG. 7A) since light which is incident during reflection is reflected on the layer 34 and hence a double light passage is effected.

A dielectric computer-generated hologram (CGH) having five phase steps was produced on a reflection basis. A hole structure with a square base face was used for first tests. On a substrate which was coated with Cr (as reflecting layer), a resist for the electron beam lithography (E-beam resist, FEP 171) with a thickness of approx. 300 nm was thereby applied. FIG. 8A shows the developed resist in an REM recording.

FIG. 8B shows the developed resist of a 3-phase element in an REM recording. The 3-phase element is constructed from full and empty pixels and also pixels with a height step, the first face of all pixels with a height step having approximately the same extension. The side length of the base face of the pixels of the element is approximately 400 nm. Production of the 3-phase element illustrated in FIG. 8B was effected comparably to the 5-phase element illustrated in FIG. 8A.

Very good results in the visible range were able to be produced with a 3-step element which is designed similarly to the element illustrated in FIG. 8B. The 3-step element used with a pixel size of 400 nm had a reflecting chromium layer of 80 nm thickness, whereupon an approx. 270 nm thick FEP layer was structured such that, with it, a phase distribution which effects an asymmetrical intensity distribution is generated. The aim of such an element is to suppress as effectively as possible the symmetrical order occurring in addition in the case of conventional phase elements with only two height steps, as is possible in general only with multilevel phase elements.

FIG. 9 shows that, with the 3-step element at a wavelength of 473 nm, an asymmetrical intensity distribution is achieved, the disc on the left in the picture which is designated as −1^{st} order is clearly pronounced whilst the disc on the right in the picture which is designated as 1^{st} order is extensively suppressed. The 0^{th} order which appears as a light dot in the centre of FIG. 9 is produced from an element height of the holes which is chosen to be too high, from a height difference between first and second face of the pixels which is too large. The zeroth order can however be extensively suppressed by suitable choice of the height difference.

With this proposal according to the invention, production of an arbitrary phase distribution with a quasi-continuous phase is possible. Hence various application possibilities are provided. Thus they can be used for testing an arbitrary phase function of a phase element, e.g. for testing aspherical lens systems. Furthermore, phase elements produced in this way can be used for beam formation. In addition, arbitrary intensity distributions in the Fraunhofer region can be produced. An asymmetrical intensity distribution can thereby be achieved, as is possible otherwise only in the case of multilevel elements. The invention is hereby distinguished by CGHs with very high, previously impossible, radiation angles being able to be produced by means of the small pixel size of the produced phase structure. The phase elements can be produced in transmission and reflection.

1-13. (canceled)

14. A diffractive optical element for generating a phase distribution with an arbitrary quasi-continuous phase deviation, the diffractive optical element comprising:
a plurality of pixels configured to generate an adjustable phase deviation, each pixel having a base face, the plurality of pixels being disposed adjacent each other with their base faces in an element plane of the diffractive optical element,
wherein one or more pixels of the plurality of pixels includes a height profile formed by a first face and a second face of the one or more pixels, a distance between the first face and second face defining a height step that is tuned to an adjustable maximum phase deviation of the diffractive optical element, the height steps of the one or more pixels being substantially the same,
wherein the first face and the base face define a face ratio by means of which a phase deviation between a minimum and the maximum phase deviation of the diffractive optical element can be adjusted continuously, and
wherein the pixels include at least two types of pixels, the types of pixels differing from each other with respect to a shaping and/or an extension of the first face of the pixels or a pixel design, the pixels disposed relative to each other such that they form a pattern without periodic repetition.

15. The diffractive optical element of claim 14, wherein the first face of at least one of the one or more pixels includes a surface profile having an arbitrary shaping and/or extension.

16. The diffractive optical element of claim 15, wherein the first face includes at least one of a column, hole, groove, or web.

17. The diffractive optical element of claim 14, wherein the second face of at least one of the one or more pixels forms a part of the base face of the at least one of the one or more pixels.

18. The diffractive optical element of claim 14, wherein the base face of at least one of the one or more pixels has a triangular or polygonal configuration and/or a maximum lateral extension of the base face is less than 5λ.

19. The diffractive optical element of claim 18, wherein the polygonal configuration is square or hexagonal.

20. The diffractive optical element of claim 18, wherein the maximum lateral extension of the base face is less than 2λ.

21. The diffractive optical element of claim 14, wherein the first face or the second face of at least one of the one or more pixels has a symmetrical shape.

22. The diffractive optical element of claim 21, wherein the symmetrical first face or second face has a square or circular shape that is centered with respect to the base face.

23. The diffractive optical element of claim 21, wherein the symmetrical first face or second face has a square or circular shape that is positioned off center with respect to the base face.

23. The diffractive optical element of claim 14, wherein the first face or the second face of at least one of the one or more pixels has an asymmetrical shape.

24. The diffractive optical element of claim 23, wherein the asymmetrical first face or second face has a rectangular or oval shape that is centered with respect to the base face.

25. The diffractive optical element of claim 23, wherein the asymmetrical first face or second face has a rectangular or oval shape that is off center with respect to the base face.

26. The diffractive optical element of claim 14, wherein the second face is in the plane of the base face and abuts at least a portion of an outer edge of the base face and/or surrounds the projection of the first face on the base face.

27. The diffractive optical element of claim 14, wherein the second face is surrounded by the projection of the first face on the base face and the projection of the first face abuts completely against an outer edge of the base face.

28. The diffractive optical element of claim 14, wherein the optical element further comprises one or more pixels without a height profile.

29. The diffractive optical element of claim 28, wherein an upper side of the one or more pixels without a height profile is situated in a plane with the first face or the second face of the one or more pixels with a height profile.

30. The diffractive optical element of claim 14, wherein the height step between first and second face of the one or more pixels with a height profile is in the range of 0 to 4λ.

31. The diffractive optical element of claim 14, wherein the diffractive optical element is configurable for transmission or reflection.

32. The diffractive optical element of claim 14, wherein the diffractive optical element is comprised of a material with a refractive index in the range of 1 to 4.

33. The diffractive optical element of claim 14, wherein the element plane of the diffractive optical element has a planar, concave or convex configuration, or has a complex basic structure.
